(19) United States
(12) Patent Application Publication
(10) Pub. No.: US 2017/0220427 A1
(43) Pub. Date: Aug. 3, 2017

(54) Data Recovery Method and Storage Device

(71) Applicant: Huawei Technologies Co., Ltd., Shenzhen (CN)

(72) Inventors: Gaoding Fu, Chengdu (CN); Yong Jiang, Chengdu (CN); Zian Mu, Chengdu (CN)

(21) Appl. No.: 15/491,473

(22) Filed: Apr. 19, 2017

Related U.S. Application Data
(63) Continuation of application No. PCT/CN2016/073038, filed on Feb. 1, 2016.

(51) Int. Cl. G06F 11/14; G06F 17/30; G06F 3/06

(52) U.S. Cl. CPC G06F 11/1469; G06F 3/0604; G06F 3/0659; G06F 3/0683; G06F 17/30088; G06F 11/1464; G06F 2201/84

(57) ABSTRACT

A data recovery method includes receiving a first physical address of a data block included in a to-be-recovered file sent by a server, searching in a recovery snapshot according to the first physical address of the data block included in the to-be-recovered file, obtaining a second physical address, in a resource volume, of a modified data block in the to-be-recovered file according to a correspondence between a first physical address of the modified data block and the second physical address, in the resource volume, of the modified data block recorded in the recovery snapshot, where the recovery snapshot is a snapshot volume used to recover the to-be-recovered file, and recovering, in the source volume, the to-be-recovered file according to the second physical address, in the resource volume, of the modified data block in the to-be-recovered file.

### CROSS-REFERENCE TO RELATED APPLICATIONS

This application is a continuation of International Patent Application No. PCT/CN2016/073038 filed on Feb. 1, 2016, which is hereby incorporated by reference in its entirety.

### TECHNICAL FIELD

The present disclosure relates to the field of storage, and in particular, to a data recovery method and a storage device.

### BACKGROUND

With gradual recognition of technologies such as cloud computing and big data by enterprises, increasing enterprises are constructing their own cloud data centers for providing services for users, to seize decisive market opportunities and win the favor of customers. However, a big issue inevitable faced during construction of a data center is how to ensure security and reliability of data of users. A server in the data center often experiences unplanned downtime due to a natural disaster such as a fire, a flood, or an earthquake, resulting service interruption, and also encounters service interruption resulting from a human factor such as a misoperation, a software error, or virus invasion. Once a service is interrupted, an unpredictable loss may be caused to an enterprise.

A snapshot technology is proposed to ensure that a service runs smoothly. A snapshot mainly can be used for online data backup and recovery. Rapid data recovery can be performed to recover data to a status at a particular snapshot time point when an application fault or file damage occurs on a storage device. For a conventional storage array snapshot technology, a mapping relationship between original data in a source volume (a backed-up logical unit number (LUN)) and a physical address of the original data is recorded using a bitmap mapping table, as shown in FIG. 1. A storage array creates a snapshot volume in another LUN when a snapshot time point arrives, the snapshot volume includes a bitmap mapping table and a resource volume, and the bitmap mapping table records a mapping relationship between original data in the source volume and a physical address of the original data. After the source volume is snapshotted, if data in the source volume is modified, modified original data in the source volume is recorded in the resource volume, and a mapping relationship between the physical address of the original data in the bitmap mapping table and an address, in the resource volume, for storing the original data is established. As shown in FIG. 1, during snapshotting, the storage array records, in the bitmap mapping table, physical addresses of a data block 0 to a data block 7 in the source volume. After snapshotting, as shown in FIG. 2, when an original data d in the source volume needs to be updated to s, first the original data d in the source volume is moved to the resource volume, then a mapping relationship between a physical address of the original data in the bitmap mapping table and a physical address, in the resource volume, for storing the original data is established, and then updated data s is written to the source volume. Similarly, the original data c may be recorded in the resource volume when data c in the source volume is updated to t. When data in the source volume is damaged, recovering to data at a snapshot point may be implemented by means of rolling back snapshot data, that is, an original data block recorded in the resource volume in the snapshot volume is migrated to a corresponding location in the source volume such that the data in the source volume is recovered to the data at the snapshot time point. As shown in FIG. 2, when data needs to be rolled back to the snapshot time point, because data in other blocks in the source volume does not change, only the original data d and c recorded in the resource volume need to be copied to locations of block 3 and block 2 in the source volume.

However, because a human misoperation or virus invasion damages only some files in the source volume, for example, only data in the block 2 is damaged, data of all files in the source volume is recovered to the snapshot time point if the foregoing snapshot data rollback manner is used to recover data, that is, both the data in the block 2 and data in the block 3 are recovered to the data d and c at the snapshot time point. However, the undamaged data does not need to be recovered if data modified after the snapshot time point is not damaged, that is, the data s written to the block 3 after the snapshot point does not need to be recovered. If the existing recovery manner is used, not only recovery of only a damaged file cannot be implemented, but also all data recorded in the resource volume needs to be migrated to the source volume, resulting in low recovery efficiency.

### SUMMARY

The embodiment of the present disclosure provides a data recovery method and a storage device in order to recover only some files in a source volume.

A first aspect of the embodiments of present disclosure provides a data recovery method, where the recovery method is applied to a storage device, the storage device includes a source volume, and the source volume includes multiple data blocks. A server snapshots the source volume at a first snapshot time point to obtain a snapshot volume, where the snapshot volume records a first physical address corresponding to, at the first snapshot time point, each data block included in the source volume. If a data block in the source volume is modified before a second snapshot time point, the modified data block in the source volume is moved to a resource volume for storage, and a correspondence between a first physical address of the modified data block and a second physical address of the modified data block in the resource volume is established in the snapshot volume, where the second snapshot time point is a next snapshot time point of the first snapshot time point. The data recovery method further includes the following.

First, the server needs to obtain a first physical address of a data block included in a to-be-recovered file.

After receiving the first physical address of the data block included in the to-be-recovered file sent by the server, the storage device searches in a recovery snapshot according to the first physical address of the data block included in the to-be-recovered file, and then obtains a second physical address, in the resource volume, of a modified data block in the to-be-recovered file according to a correspondence between a first physical address of the modified data block and the second physical address, in the resource volume, of the modified data block recorded in the recovery snapshot, where the recovery snapshot is a snapshot volume used to recover the to-be-recovered file.

Finally, the storage device recovers, in the source volume, the to-be-recovered file according to the second physical address, in the resource volume, of the modified data block in the to-be-recovered file.

Optionally, recovering, by the storage device in the source volume, the to-be-recovered file according to the second physical address, in the resource volume, of the modified data block in the to-be-recovered file further includes finding, in the resource volume by the storage device, the modified data block according to the second physical address, in the resource volume, of the modified data block in the to-be-recovered file, and then recovering, in the source volume, the to-be-recovered file using the modified data block.

By means of the foregoing method, specified recovery can be performed on a selected file (for example, some damaged files) that needs to be recovered, without the need to entirely copy all data in a snapshot volume to a source volume. Therefore, a file not damaged is not overwritten, and efficiency of data recovery can also be greatly improved.

In a scenario in which data of some files in a source volume used by a production host is modified, a specific implementation manner of obtaining, by the server, the first physical address of the data block included in the to-be-recovered file includes determining, by the server, the to-be-recovered file according to an input of a user, and sending, by the server, an identifier (ID) of the to-be-recovered file to the production host, to obtain the first physical address of the data block included in the to-be-recovered file from the production host.

A method for obtaining, by the production host, the first physical address after receiving the ID of the to-be-recovered file sent by the server further includes querying, by the production host according to the ID of the to-be-recovered file, metadata of a file system to which the to-be-recovered file belongs, querying, by the production host according to the metadata of the file system, the first physical address of the data block included in the to-be-recovered file, and sending, by the production host, the first physical address of the data block included in the to-be-recovered file to the server.

In this way, the server can send the obtained first physical address of the data block included in the to-be-recovered file to the storage device.

In a scenario in which some files in a source volume used by a production host are deleted, a specific implementation manner of obtaining, by the server, the first physical address of the data block included in the to-be-recovered file includes determining, by the server, an ID of a backup host and an ID of a recovery snapshot according to an input of a user, sending, by the server, the ID of the backup host and the recovery snapshot to the storage device, receiving, by the storage device, the ID of the backup host and the recovery snapshot that are sent by the server, and mapping the recovery snapshot to the backup host, mounting, by the server, a file system in the recovery snapshot to the backup host, and obtaining a file list of backup files in the recovery snapshot using the backup host, determining, by the server, the to-be-recovered file according to the file list of the backup files, and sending an ID of the to-be-recovered file to the backup host, to obtain the first physical address of the data block included in the to-be-recovered file.

A method for obtaining the first physical address by the backup host further includes querying, by the backup host according to the ID of the to-be-recovered file, metadata of a file system to which the to-be-recovered file belongs, querying, by the backup host according to the metadata of the file system, the first physical address of the data block included in the to-be-recovered file, and sending, by the backup host, the first physical address of the data block included in the to-be-recovered file to the server.

In this way, the server sends the obtained first physical address of the data block included in the to-be-recovered file to the storage device.

A second aspect of the embodiment of the present disclosure provides a storage device, where the storage device includes a receiving unit and a processing unit, where the receiving unit is configured to receive a first physical address of a data block included in a to-be-recovered file sent by a server, and the processing unit is configured to search in a recovery snapshot according to the first physical address of the data block included in the to-be-recovered file, and obtain a second physical address, in a resource volume, of a modified data block in the to-be-recovered file according to a correspondence between a first physical address of the modified data block and the second physical address, in the resource volume, of the modified data block recorded in the recovery snapshot, where the recovery snapshot is a snapshot volume used to recover the to-be-recovered file, and then recover, in the source volume, the to-be-recovered file according to the second physical address, in the resource volume, of the modified data block in the to-be-recovered file.

In possible design, the storage device includes multiple snapshot volumes obtained by means of snapshotting at multiple snapshot time points, and the recovery snapshot is one of the multiple snapshot volumes, and a method for determining the recovery snapshot from the multiple snapshot volumes includes receiving, by the receiving unit, an ID of the recovery snapshot sent by the server, and determining, by the processing unit, the recovery snapshot from the multiple snapshot volumes according to the ID of the recovery snapshot.

The recovery snapshot needs to be mounted to a backup host before the first physical address of the data block included in the to-be-recovered file can be obtained when the to-be-recovered file is a deleted file, and a specific implementation manner includes receiving, by the receiving unit, an ID of the backup host that is sent by the server, and mapping, by the processing unit, the recovery snapshot to the backup host such that the backup host obtains, according to the recovery snapshot, the first physical address of the data block included in the to-be-recovered file, and sends the first physical address of the data block included in the to-be-recovered file to the server.

In possible design, the processing unit is configured to recover, in the source volume, the to-be-recovered file according to the second physical address, in the resource volume, of the modified data block in the to-be-recovered file includes finding, in the resource volume by the processing unit, the modified data block according to the second physical address, in the resource volume, of the modified data block in the to-be-recovered file, and then recovering, in the source volume, the to-be-recovered file using the modified data block.

Another aspect of an embodiment of the present disclosure further provides a storage device, including a processor and a memory, where the memory is configured to store an instruction, the processor is configured to execute the instruction, and when the instruction is executed by the processor, the storage device is caused to perform the data recovery method according to the first aspect.

It can be learned from the foregoing technical solutions that, the embodiments of the present disclosure have the following advantages. The user only needs to select a to-be-recovered file in a server if a user needs to perform data recovery on some files whose data is modified or deleted in a source volume used by a production host. After obtaining, according to an ID of the to-be-recovered file, a first physical address of a data block included in the to-be-recovered file, the server sends the first physical address to a storage device, and the storage device searches in a recovery snapshot according to the first physical address of the data block included in the to-be-recovered file, to obtain a modified data block, in the recovery snapshot, that is recorded in a resource volume, and then recovers, in the source volume, the to-be-recovered file according to the modified data block recorded in the resource volume. According to the embodiments of the present disclosure, specified recovery can be performed on a selected file (for example, some damaged files) that needs to be recovered, without the need to entirely copy all data in a snapshot volume to a source volume. Therefore, an updated file that is not damaged is not overwritten, and efficiency of data recovery can also be greatly improved.

### BRIEF DESCRIPTION OF DRAWINGS

FIG. 1 is a schematic diagram of generating a snapshot of a resource volume;

FIG. 2 is another schematic diagram of data recovery according to the generated snapshot of FIG. 1;

FIG. 3 is a schematic diagram of a scenario deployment of a data recovery method according to an embodiment of the present disclosure;

FIG. 4 is a schematic flowchart of an embodiment of a data recovery method according to an embodiment of the present disclosure;

FIG. 5 is a schematic flowchart of a data recovery method according to another embodiment of the present disclosure;

FIG. 6 is another schematic diagram of data recovery using a snapshot according to an embodiment of the present disclosure;

FIG. 7 is another schematic diagram of data recovery using a snapshot according to an embodiment of the present disclosure;

FIG. 8 is another schematic diagram of data recovery using a snapshot according to an embodiment of the present disclosure;

FIG. 9 is another schematic diagram of data recovery using a snapshot according to an embodiment of the present disclosure;

FIG. 10 is a schematic structural diagram of an embodiment of a storage device according to an embodiment of the present disclosure; and

FIG. 11 is a schematic structural diagram of a storage device according to another embodiment of the present disclosure.

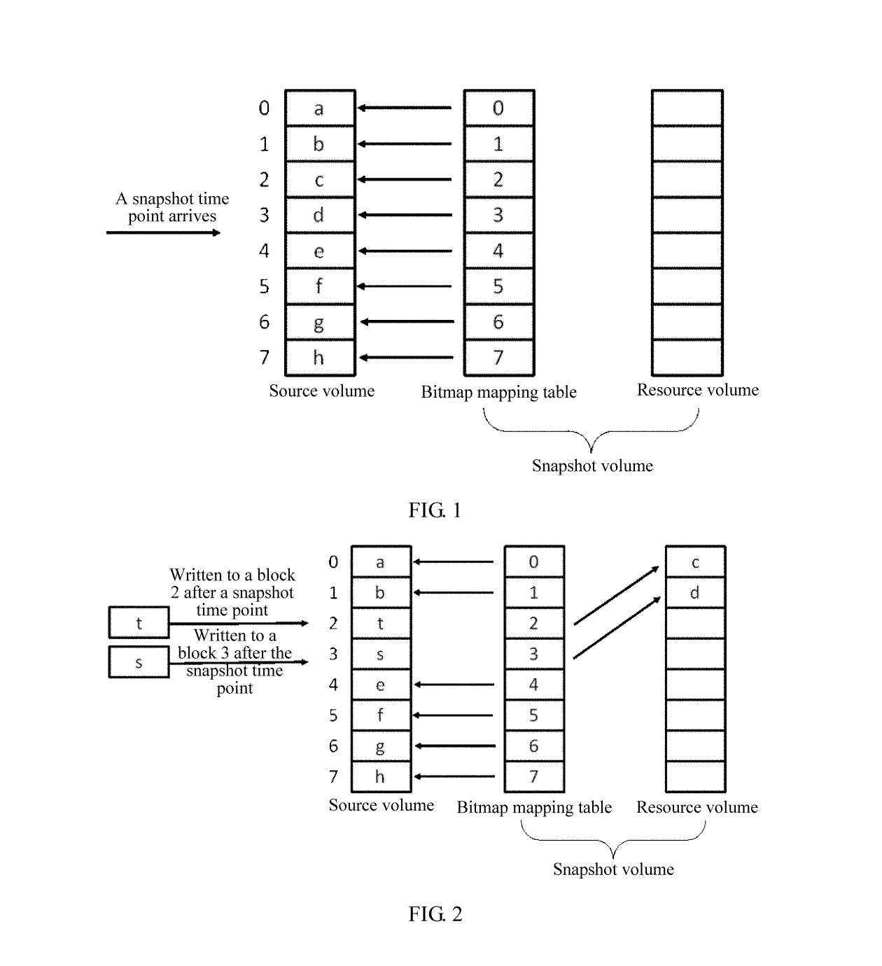

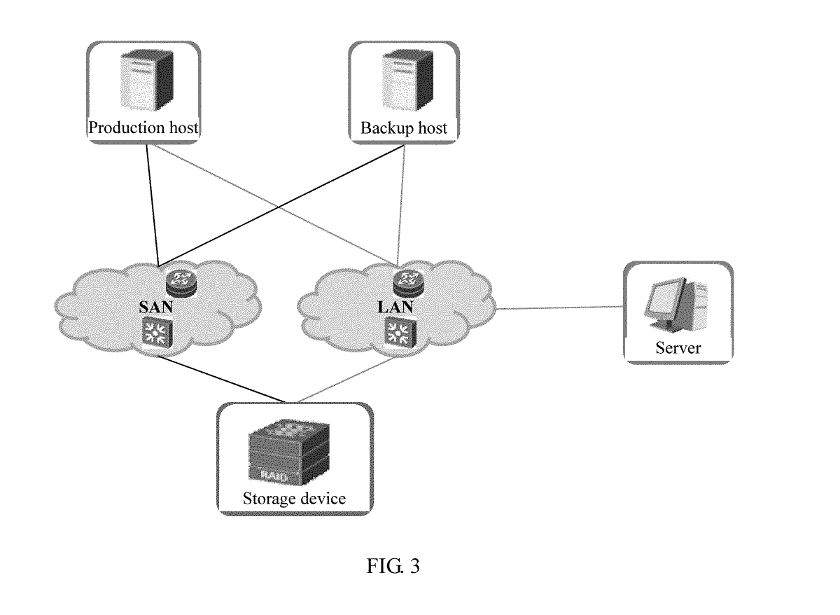

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

As shown in FIG. 3, FIG. 3 is a possible scenario deployment for implementing a data recovery method of the present disclosure. Physical entities included in FIG. 3 are mainly hosts, a storage device, and a server. For ease of description, in FIG. 3, related devices are named in conformity with the scenario, but corresponding functions of the devices are not limited, and quantities of the devices are not limited in an actual deployment. FIG. 3 includes a production host (or referred to as a service host) running a service, and a backup host for the production host. When the production host encounters a fault or needs to be maintained, the backup host may be started. FIG. 3 further includes a storage device and a server. The server (for example, a disaster recovery management (DRM) server) is mainly responsible for centralized management of data disaster recovery. For example, the server manages all production hosts for which disaster recovery is required and storage arrays/devices used by the production hosts, and may generate, according to a particular time policy (for example, every hour/every day), a snapshot for storage space (that is, a source volume) corresponding to a LUN used by a production host. In the production host and the backup host in FIG. 3, a service agent needs to be deployed such that the production host and the backup host have the function of collecting information about a physical address, in a storage array/device, of a file in the production host. In FIG. 3, the server and the production host/backup host are connected using a local area network (LAN), and communicate using a representational state transfer (REST) interface. The production host, the backup host, and the storage array/device are connected using a storage area network (SAN), and the production host and the backup host use a storage LUN provided by the storage array/device.

Before data recovery, it is assumed that the server has managed the storage array/device and the service host (for example, the production host and the backup host), and the server has obtained, using a service agent in the production host, information about files (for example, a data file, a control file, and a log file) in the production host and a source volume that stores the files, and has generated, according to a particular time policy (for example, every hour), a storage snapshot volume for the source volume that stores the files, to complete backup of the files (for example, the data file, the control file, and the log file) in the production host.

It is assumed that the server obtains the snapshot volume by snapshotting the source volume at a first snapshot time point, and the obtained snapshot volume records a first physical address, in the source volume at the first snapshot time point, of each data block included in the source volume. If a data block in the source volume is modified before a next snapshot time point of the first snapshot time point, that is, a second snapshot time point, the modified data block in the source volume is moved by the server to a resource volume for storage, and the server establishes, in the snapshot volume, a correspondence between a first physical address of the modified data block and a second physical address, in the resource volume, of the modified data block.

In the technical solutions of the present disclosure, after some files in the source volume are deleted or data of some files is modified, the deleted or modified files may be recovered using data in the snapshot volume.

For ease of understanding, a method for recovering, when some files in a source volume are modified, the modified files using a snapshot, and a method for recovering, when some files in a source volume are deleted, the deleted files using a snapshot are separately described below.

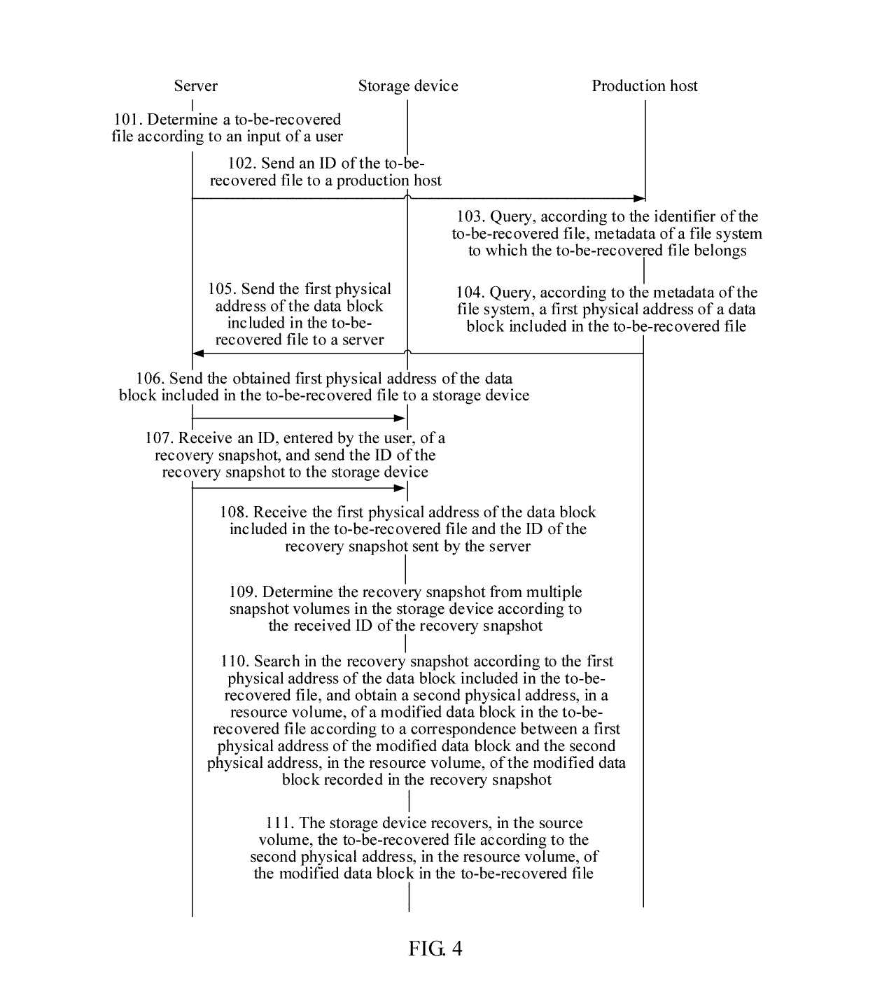

As shown in FIG. 4, FIG. 4 is a schematic flowchart of a method for recovering, when some files in a source volume are modified, the modified files using a snapshot. The recovery method includes the following steps.

Step 101: A server determines a to-be-recovered file according to an input of a user.

In this step, the user needs to log in to the server and select the to-be-recovered file. For example, a file that needs to be recovered is selected according to information (such as file names or paths) about files in a production host that is stored in the server.

Step 102: The server sends an ID of the to-be-recovered file to a production host.

In this step, the server sends the ID of the to-be-recovered file to the production host, to obtain a first physical address of a data block included in the to-be-recovered file in the production host. The first physical address is an address of the to-be-recovered file in the source volume. Further, the server delivers the ID of the to-be-recovered file to the production host using a REST interface, and the production host queries the first physical address of the data block included in the to-be-recovered file using an agent deployed in the production host, and sends the first physical address to the server. A method for obtaining the first physical address by the production host includes the following steps 103 to 105.

Step 103: The production host queries, according to the ID of the to-be-recovered file, metadata of a file system to which the to-be-recovered file belongs.

Step 104: The production host queries, according to the metadata of the file system, a first physical address of a data block included in the to-be-recovered file.

Step 105: The production host sends the first physical address of the data block included in the to-be-recovered file to the server.

Step 106: The server sends the obtained first physical address of the data block included in the to-be-recovered file to a storage device.

Step 107: The server receives an ID, entered by the user, of a recovery snapshot, and sends the ID of the recovery snapshot to the storage device.

Further, the server sends the first physical address of the data block included in the to-be-recovered file and the ID of the recovery snapshot to the storage device using a REST interface.

It should be noted that, step 107 may be performed after step 106 is completely performed, or may be performed before step 106 is completely performed. Alternatively, the ID of the recovery snapshot may be sent to the storage device at the same time when the first physical address of the data block included in the to-be-recovered file is sent to the storage device. A sequence of performing steps 106 and 107 is not limited herein.

In addition, if the server performs snapshotting only once, that is, there is only one snapshot volume in the storage device, step 107 may not be performed.

Step 108: The storage device receives the first physical address of the data block included in the to-be-recovered file and the ID of the recovery snapshot sent by the server.

It should be noted that, when the server does not perform step 107, in step 108, the storage device receives only the first physical address, which is sent by the server, of the data block included in the to-be-recovered file.

Step 109: The storage device determines the recovery snapshot from multiple snapshot volumes in the storage device according to the received ID of the recovery snapshot.

Similarly, when the server does not perform step 107, the step 109 may not be performed. Because there is only one snapshot volume in the storage device, it may be determined that the only snapshot volume in the storage device is the recovery snapshot.

Step 110: The storage device searches in the recovery snapshot according to the first physical address of the data block included in the to-be-recovered file, and obtains a second physical address, in a resource volume, of a modified data block in the to-be-recovered file according to a correspondence between a first physical address of the modified data block and the second physical address, in the resource volume, of the modified data block recorded in the recovery snapshot, where the recovery snapshot is a snapshot volume used to recover the to-be-recovered file.

Step 111: The storage device recovers, in the source volume, the to-be-recovered file according to the second physical address, in the resource volume, of the modified data block in the to-be-recovered file.

Optionally, recovering, in the source volume, the to-be-recovered file according to the second physical address, in the resource volume, of the modified data block in the to-be-recovered file includes finding, in the resource volume, the modified data block according to the second physical address, in the resource volume, of the modified data block in the to-be-recovered file, and recovering, in the source volume, the to-be-recovered file using the modified data block.

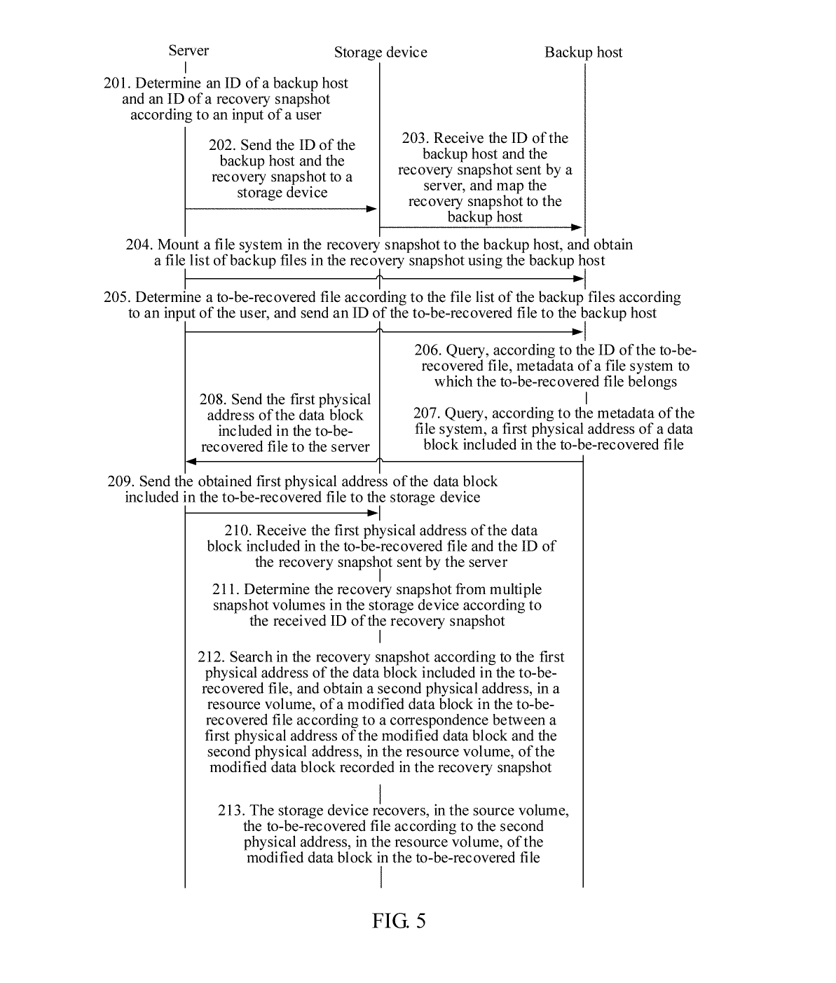

As shown in FIG. 5, FIG. 5 is a flowchart of a data recovery method in a scenario in which some files in a source volume used by a production host are deleted. The method includes the following steps.

Step 201: A server determines an ID of a backup host and an ID of a recovery snapshot according to an input of a user.

In this step, the user needs to log in to the server, and selects the ID of the backup host and a recovery snapshot to recover a to-be-recovered file.

It should be noted that, after a file in the source volume is deleted, in a file system of the production host, a first physical address of the deleted file also does not exist, but when the server snapshots the source volume, a file system, which includes first physical addresses of files, in the source volume is also stored in a snapshot volume. Therefore, to obtain a physical address of the to-be-recovered deleted file, the ID of the backup host and the ID of the recovery snapshot need to be entered by the user in order to obtain the first physical address of the deleted to-be-recovered file using the backup host and the recovery snapshot.

Step 202: The server sends the ID of the backup host and the recovery snapshot to a storage device.

Step 203: The storage device receives the ID of the backup host and the recovery snapshot sent by the server, and maps the recovery snapshot to the backup host.

The storage device determines the backup host according to the ID of the backup host, and maps the received recovery snapshot to the backup host such that the backup host reads/writes the recovery snapshot.

Step 204: The server mounts a file system in the recovery snapshot to the backup host, and obtains a file list of backup files in the recovery snapshot using the backup host.

Further, the server notifies, using a REST interface, that the file system is to be deployed in the backup host, and the backup host mounts the file system in the recovery snapshot to a specified mount point (for example, a D or E partition in a WINDOWS operating system, or /opt/data1 or /opt/data2 in a Linux operating system) in the backup host using an agent deployed in the backup host in order to obtain the file list of the backup files in the recovery snapshot.

Step 205: The server determines a to-be-recovered file from the file list of the backup files according to an input of the user, and sends an ID of the to-be-recovered file to the backup host.

In this step, the user needs to log in to the server, and selects the to-be-recovered file from the file list of the backup files. The server sends the ID of the determined to-be-recovered file to the backup host using a REST interface. The backup host queries, using an agent deployed in the backup host, a first physical address of a data block included in the to-be-recovered file, and sends the first physical address to the server. A method for obtaining the first physical address by the backup host includes the following steps 206 to 208.

Step 206: The backup host queries, according to the ID of the to-be-recovered file, metadata of a file system to which the to-be-recovered file belongs.

Step 207: The backup host queries, according to the metadata of the file system, a first physical address of a data block included in the to-be-recovered file.

Step 208: The backup host sends the first physical address of the data block included in the to-be-recovered file to the server.

Steps 209 to 213 describe recovery of the to-be-recovered file by the storage device after the storage device receives the first physical address of the data block included in the to-be-recovered file. A method for recovering the file is the same as the method for recovering a modified file, that is, steps 106, and 108 to 111, described in FIG. 4, and details are not described herein again.

Optionally, after recovery of the to-be-recovered file is completed in step 213, the server may instruct, using a REST interface, the backup host to unmount the file system in the recovery snapshot from the backup host, and de-map the recovery snapshot from the backup host, to reduce occupation of resources in the backup host, and prevent a misoperation from damaging data in the recovery snapshot.

In this embodiment of the present disclosure, the user only needs to select a to-be-recovered file in a server if a user needs to perform data recovery on some files whose data is modified or deleted in a source volume used by a production host. After obtaining, according to an ID of the to-be-recovered file, a first physical address of a data block included in the to-be-recovered file, the server sends the first physical address to a storage device, and the storage device searches in a recovery snapshot according to the first physical address of the data block included in the to-be-recovered file, to obtain a modified data block, in the recovery snapshot, that is recorded in a resource volume, and then recovers, in the source volume, the to-be-recovered file according to the modified data block recorded in the resource volume. According to the present disclosure, specified recovery can be performed on a selected file (for example, some damaged files) that needs to be recovered, without the need to entirely copy all data in a snapshot volume to a source volume. Therefore, an updated file that is not damaged is not overwritten, and efficiency of data recovery can also be greatly improved.

For ease of understanding, the data recovery method in this embodiment of the present disclosure is further described below using a specific application scenario.

In this scenario, descriptions are provided using an example in which, when some files in a source volume are modified, the modified files are recovered using a snapshot, and for a scenario in which some files are deleted, refer to this description correspondingly.

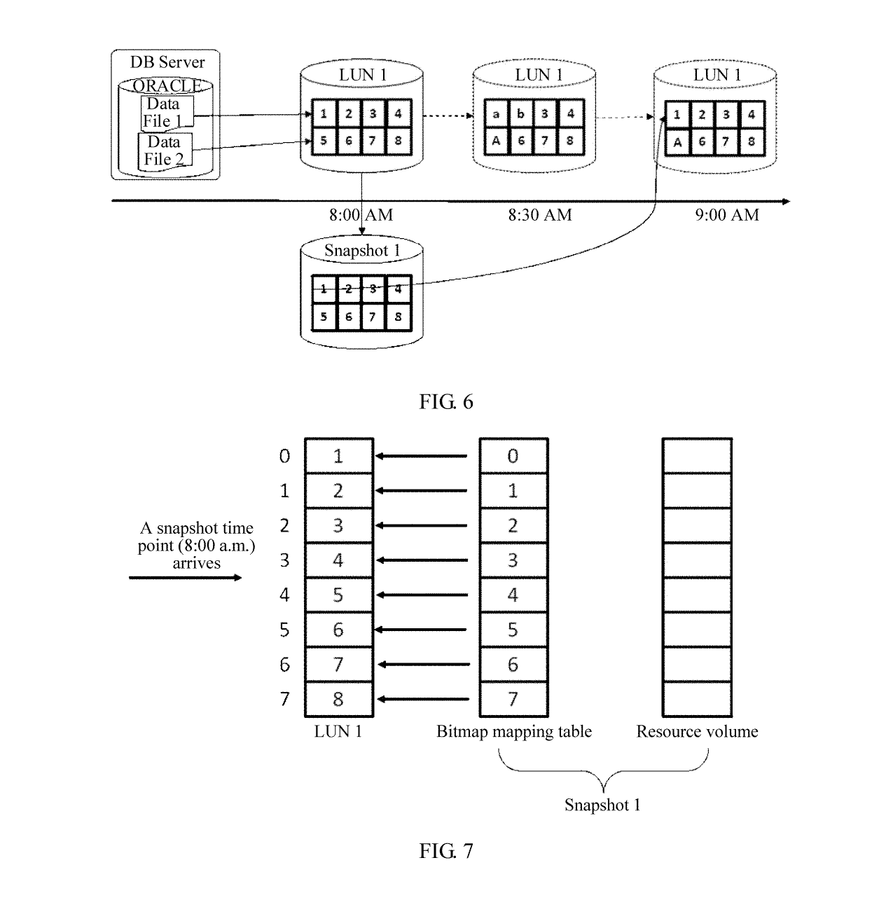

As shown in FIG. 6, an ORACLE (ORACLE is a relational database management system of ORACLE Corporation, and is used only as an example of an application scenario for description herein) database runs on a database server (designated as DB Server). In the figure, there are two data files, DataFile1 and DataFile2, in the database, and the data files are stored in a LUN 1 for storage, that is, a source volume. It is assumed that a starting physical address of data blocks in the LUN 1 corresponding to DataFile1 is 0, and an ending physical address is 3, and stored data is 1, 2, 3, and 4 respectively, and a starting physical address of data blocks in the LUN 1 corresponding to DataFile2 is 4, and an ending physical address is 7, and stored data is 5, 6, 7, and 8 respectively. A process of data damage and recovery is shown in the figure, and a specific process with reference to the present disclosure is as follows.

For example, the server creates a storage snapshot Snapshot1 for the LUN 1 at 8:00 a.m. As shown in FIG. 7, when the snapshot time point 8:00 arrives, Snapshot1 is created for the data, in the LUN 1 corresponding to DataFile1 and DataFile2.

Referring to FIG. 6 and FIG. 8, at 8:30 a.m., DataFile1 is artificially damaged. For example, the data 1 and 2 whose physical addresses of corresponding data blocks in the LUN 1 are 0 and 1 are modified (for example, the data 1 and 2 in FIG. 6 and FIG. 8 are modified as a and b). Data in DataFile2 continues to be updated, for example, data at the physical address 4 in the source volume in FIG. 8 is updated to A.

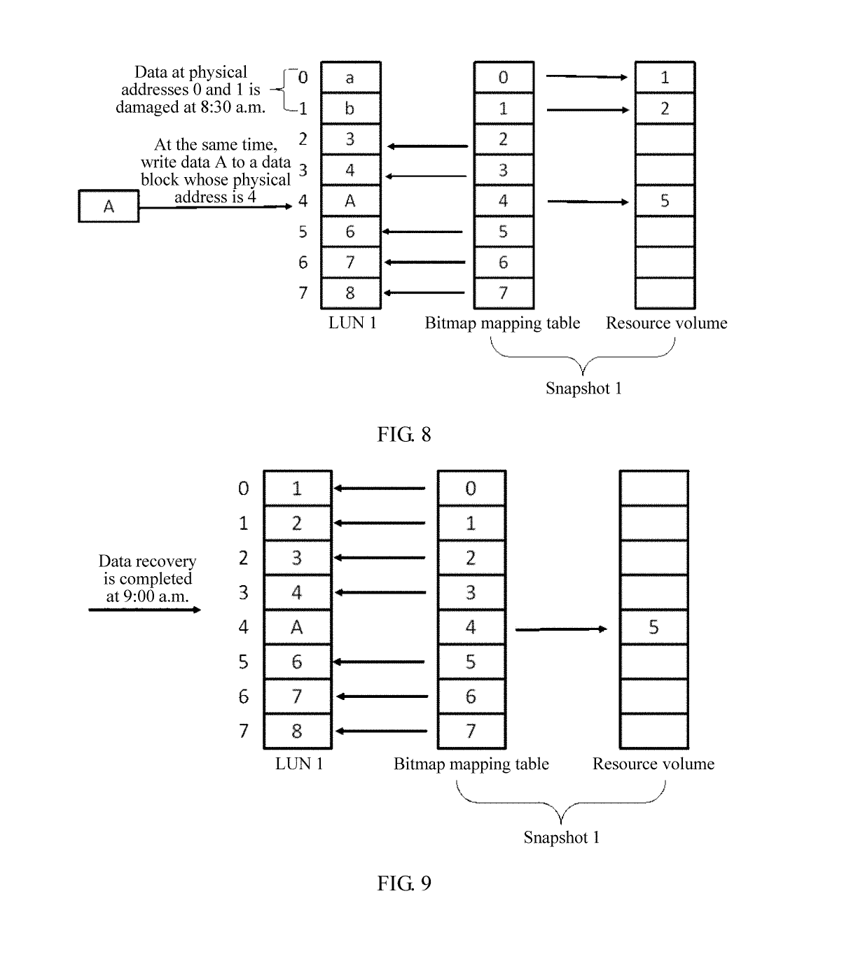

If the data in DataFile2 that continues to be updated is useful data, data recovery needs to be performed only on damaged DataFile1, and by means of the technical solutions of the present disclosure, DataFile1 is selected for data recovery. FIG. 6 shows a status at 9:00 a.m. after data recovery is completed. A specific recovery process is as follows. Snapshot1 is selected as a recovery snapshot used to recover DataFile1, and the server determines the to-be-recovered file DataFile1 according to an input of a user, to obtain physical addresses (physical addresses corresponding to the data 1 to 4 in FIG. 6, where these physical addresses are 0 to 3 in FIG. 8) of the data blocks included in DataFile1. After obtaining the physical addresses of the data blocks included in DataFile1, the server sends the physical addresses of the data blocks included in DataFile1 and an ID of Snapshot1 to a storage device. After receiving the physical addresses of the data blocks included in DataFile1 and the ID of Snapshot1 sent by the server, the storage device first determines the recovery snapshot Snapshot1 corresponding to the ID of Snapshot1, and then obtains physical addresses, in a resource volume, of modified data blocks in the to-be-recovered file DataFile1 according to correspondences between physical addresses (the physical addresses 0 and 1 in a bitmap mapping table shown in FIG. 8) of the modified data blocks and the physical addresses (physical addresses of the data 1 and 2 in the resource volume shown in FIG. 8), in the resource volume, of the modified data blocks recorded in Snapshot1. Data blocks corresponding to the data 1 and 2 are found in the resource volume according to the physical addresses, in the resource volume, of the data 1 and 2 shown in FIG. 8, and the data 1 and 2 are copied, in the source volume, to data blocks of DataFile1 corresponding to the data 1 and 2 that are modified in the LUN 1. As shown in FIG. 9, at 9:00 a.m., the data 1 and 2 in the resource volume have been copied to the data blocks, whose data is modified in the LUN 1, of DataFile1. Therefore, by means of the data recovery method, data recovery can be performed on modified DataFile1, and data written to DataFile2 after the snapshot time point is not affected, whereas both DataFile1 and DataFile2 are recovered to the source volume in an entirely copying manner. Therefore, in this case, there is no need to entirely copy all data in a snapshot volume to a source volume when data recovery is performed using the data recovery method provided in the present disclosure. Therefore, a file that is not damaged is not overwritten, and efficiency of data recovery can also be greatly improved.

For a scenario in which some files in a source volume are deleted, also refer to the foregoing example. For example, if the foregoing DataFile1 is deleted, the data 1 to 4 whose physical addresses of corresponding data blocks in the LUN 1, 0 to 3 are deleted. Therefore, when data recovery is performed for DataFile1, the data 1 to 4 in the source volume need to be recovered. Different from the foregoing example, because a file in DataFile1 is deleted, to obtain a physical address of the deleted file in DataFile1, a user needs to enter an ID of a backup host and an ID of a recovery snapshot such that a physical address of the deleted to-be-recovered file DataFile1 is obtained using the backup host and the recovery snapshot. For a subsequent data recovery process, refer to the foregoing example, and details are not described herein again.

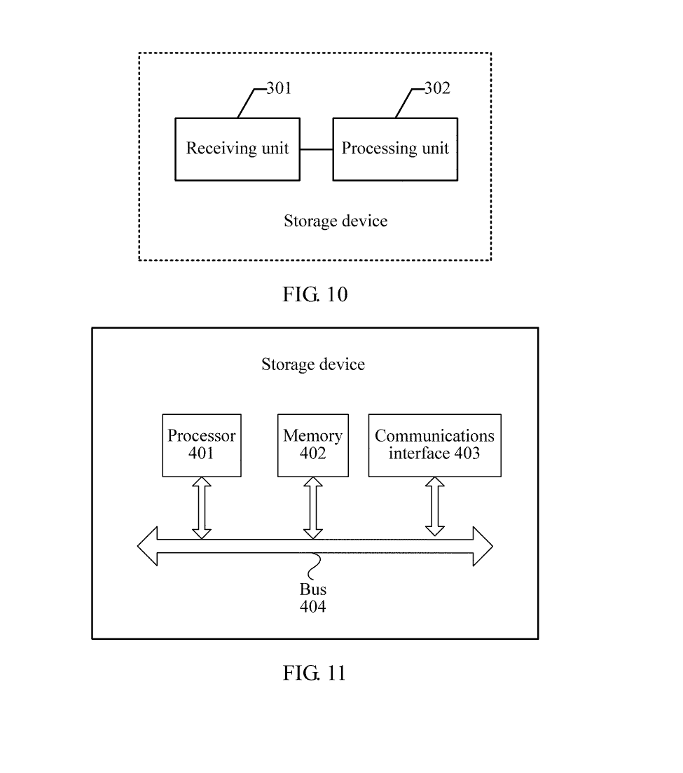

The data recovery method provided in the present disclosure is described above. A structure of a related apparatus involved in the present disclosure is described below from a perspective of an apparatus. Referring to FIG. 10, a storage device provided in the present disclosure includes a receiving unit 301 configured to receive a first physical address of a data block included in a to-be-recovered file and sent by a server, where a manner in which the server obtains the first physical address, in a source volume, of the to-be-recovered file is the same as that in the method embodiment, and details are not described herein again, and a processing unit 302 configured to search in a recovery snapshot according to the first physical address of the data block included in the to-be-recovered file, and obtain a second physical address, in a resource volume, of a modified data block in the to-be-recovered file according to a correspondence between a first physical address of the modified data block and the second physical address, in the resource volume, of the modified data block recorded in the recovery snapshot, where the recovery snapshot is a snapshot volume used to recover the to-be-recovered file, and recover, in the source volume, the to-be-recovered file according to the second physical address, in the resource volume, of the modified data block in the to-be-recovered file.

Optionally, the storage device includes multiple snapshot volumes obtained by means of snapshotting at multiple snapshot time points. The receiving unit 301 is further configured to receive an ID of the recovery snapshot and sent by the server when the storage device includes multiple snapshot volumes, and the processing unit 302 is further configured to determine the recovery snapshot from the multiple snapshot volumes according to the ID of the recovery snapshot.

Optionally, the receiving unit 301 is further configured to receive an ID of a backup host sent by the server when the to-be-recovered file is a deleted file, and the processing unit 302 is further configured to map the recovery snapshot to the backup host such that the backup host obtains, according to the recovery snapshot, the first physical address of the data block included in the to-be-recovered file, and sends the first physical address of the data block included in the to-be-recovered file to the server.

Optionally, that the processing unit 302 is configured to recover, in the source volume, the to-be-recovered file according to the second physical address, in the resource volume, of the modified data block in the to-be-recovered file, where the processing unit 302 is configured to find, in the resource volume, the modified data block according to the second physical address, in the resource volume, of the modified data block in the to-be-recovered file, and then recover, in the source volume, the to-be-recovered file using the modified data block.

A specific structure of the storage device is described from a perspective of a functional unit in the embodiment shown in FIG. 10. The specific structure of the storage device is described below from a perspective of hardware with reference to an embodiment shown in FIG. 11.

As shown in FIG. 11, a structure of the storage device provided in the present disclosure includes a processor 401 and a memory 402, and may further include a bus 404 and a communications interface 403.

Communication connections between the processor 401, the memory 402, and the communications interface 403 may be implemented using the bus 404, or communication may be implemented by means of wireless transmission or in another manner.

The memory 402 may include a volatile memory, for example, a random-access memory (RAM). The memory 402 may also include a non-volatile memory, for example, a read-only memory (ROM), a flash memory, a hard disk drive (HDD) or a solid-state drive (SSD). The memory 402 may also include a combination of the foregoing types of memories. Program code for implementing the present disclosure may be stored in the memory 402, and executed by the processor 401.

The memory 402 stores the following elements, executable modules, or data structures, or a subset thereof, or an extended set thereof. The elements are operation instructions, including various operation instructions, used to implement various operations, and an operating system, including various system programs, used to implement various fundamental services and process hardware-based tasks.

The storage device involved in this embodiment of the present disclosure may have more or fewer components than those shown in FIG. 11. Two or more components may be combined, or configuration or setting of the components may be different, and the components may be implemented in hardware, software, or a combination of hardware and software that includes one or more signal processing and/or application-specific integrated circuits.

In this embodiment of the present disclosure, the processor 401 is configured to perform steps 108 to 111 in FIG. 4.

For understanding of related descriptions of the foregoing apparatus, refer to corresponding related descriptions and effects in the method embodiment section, and details are not described herein again.

It may be clearly understood by persons skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

The integrated unit may be stored in a computer-readable storage medium when the integrated unit is implemented in the form of a software functional unit and sold or used as an independent product. Based on such an understanding, the technical solutions of the present disclosure, all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. A data recovery method, applied to a storage device, wherein the storage device comprises a source volume, wherein the source volume comprises a plurality of data blocks, wherein the source volume is snapshotted at a first snapshot time point to obtain a snapshot volume, wherein the snapshot volume records a first physical address corresponding to each data block comprised in the source volume at the first snapshot time point, wherein when a data block in the source volume is modified before a second snapshot time point, the modified data block in the source volume is moved to a resource volume for storage, wherein a correspondence between a first physical address of the modified data block and a second physical address of the modified data block in the resource volume is established in the snapshot volume, wherein the second snapshot time point is a next snapshot time point of the first snapshot time point, and wherein the method comprises:
receiving a first physical address of a data block comprised in a to-be-recovered file sent by a server;
searching, in a recovery snapshot, the first physical address of the data block comprised in the to-be-recovered file;
obtaining a second physical address, in the resource volume, of a modified data block in the to-be-recovered file according to a correspondence between a first physical address of the modified data block and a second physical address of the modified data block in the resource volume recorded in the recovery snapshot, wherein the recovery snapshot is a snapshot volume used to recover the to-be-recovered file; and
recovering, in the source volume, the to-be-recovered file according to the second physical address, in the resource volume, of the modified data block in the to-be-recovered file.

2. The method according to claim 1, wherein the storage device comprises a plurality of snapshot volumes obtained by means of snapshotting at a plurality of snapshot time points, and wherein the method further comprises:
receiving an identifier of the recovery snapshot sent by the server; and
selecting the recovery snapshot from the plurality of snapshot volumes according to the identifier of the recovery snapshot.

3. The method according to claim 1, wherein before receiving the first physical address, the method further comprises:
receiving an identifier of a backup host sent by the server; and
mapping the recovery snapshot to the backup host such that the backup host obtains, according to the recovery snapshot, the first physical address of the data block comprised in the to-be-recovered file, and sends the first physical address of the data block comprised in the to-be-recovered file to the server.

4. The method according to claim 1, wherein recovering the to-be-recovered file comprises:
finding, in the resource volume, the modified data block according to the second physical address, in the resource volume, of the modified data block in the to-be-recovered file; and
recovering, in the source volume, the to-be-recovered file using the modified data block.

5. A storage device, comprising:
a source volume, wherein the source volume comprises a plurality of data blocks, wherein the source volume is snapshotted at a first snapshot time point to obtain a snapshot volume, wherein the snapshot volume records a first physical address corresponding to each data block comprised in the source volume at the first snapshot time point, wherein when a data block in the source volume is modified before a second snapshot time point, the modified data block in the source volume is moved to a resource volume for storage, wherein a correspondence between a first physical address of the modified data block and a second physical address of the modified data block in the resource volume is established in the snapshot volume, and wherein the second snapshot time point is a next snapshot time point of the first snapshot time point;
a memory comprising instructions; and
a processor coupled to the memory, wherein the instructions cause the processor to be configured to:
receive a first physical address of a data block comprised in a to-be-recovered file sent by a server;
search, in a recovery snapshot, the first physical address of the data block comprised in the to-be-recovered file;
obtain a second physical address, in the resource volume, of a modified data block in the to-be-recovered file according to a correspondence between a first physical address of the modified data block and a second physical address of the modified data block in the resource volume recorded in the recovery snapshot, wherein the recovery snapshot is a snapshot volume used to recover the to-be-recovered file; and
recover, in the source volume, the to-be-recovered file according to the second physical address, in the resource volume, of the modified data block in the to-be-recovered file.

6. The storage device according to claim 5, further comprising a plurality of snapshot volumes obtained by means of snapshotting at a plurality of snapshot time points, wherein the instructions further cause the processor to be configured to:
receive an identifier of the recovery snapshot sent by the server; and
select the recovery snapshot from the plurality of snapshot volumes according to the identifier of the recovery snapshot.

7. The storage device according to claim 5, wherein before receiving the first physical address, the instructions further cause the processor to be configured to:
receive an identifier of a backup host sent by the server; and
map the recovery snapshot to the backup host such that the backup host obtains, according to the recovery snapshot, the first physical address of the data block comprised in the to-be-recovered file, and sends the first physical address of the data block comprised in the to-be-recovered file to the server.

8. The storage device according to claim 5, wherein when recovering the to-be-recovered file, the instructions further cause the processor to be configured to:
find, in the resource volume, the modified data block according to the second physical address, in the resource volume, of the modified data block in the to-be-recovered file; and
recover, in the source volume, the to-be-recovered file using the modified data block.
